(19) United States
(12) Patent Application Publication
(10) Pub. No.: US 2026/0219920 A1
(43) Pub. Date: Jul. 30, 2026

(54) APPROACH FOR HANDLING SYSTEM INTERRUPTS

(71) Applicant: Intel Corporation, Santa Clara, CA (US)

(72) Inventors: Yaozu DONG, Shanghai (CN); Zhiming LI, Shanghai (CN); Fang YUAN, Shanghai (CN); Yi ZENG, Shanghai (CN); Shuo LIU, Shanghai (CN); Junjie MAO, Shanghai (CN)

(21) Appl. No.: 19/142,303

(22) PCT Filed: Dec. 23, 2022
(86) PCT No.: PCT/CN2022/141379

§ 371 Date: Jun. 23, 2025

(51) Int. Cl. G06F 9/48; G06F 9/50; G06F 13/24

(52) U.S. Cl. CPC G06F 9/4812; G06F 9/5011; G06F 13/24

(57) ABSTRACT

Various examples of the present disclosure relate to a firmware apparatus, firmware device, firmware method and corresponding computer program, to a processor, method for a processor and corresponding computer program, and to a computer program. Some aspects of the present disclosure relate to various examples of the present disclosure relate to a firmware apparatus, firmware device, firmware method and corresponding computer program, to a processor, method for a processor and corresponding computer program, and to a computer program. A firmware apparatus comprises interface circuitry, machine-readable instructions and processing circuitry to execute the machine-readable instructions to provide a first entry point for handling global system interrupts, and to provide a plurality of second entry points for handling hardware partition-specific system interrupts, the plurality of second entry points being based on a plurality of hardware partitions of the computer system.

### BACKGROUND

The partitioning of servers is a technique for sub-dividing a single server into multiple partitions, which can be used, mostly independently from each other, by different systems being executed in parallel by the server. In a partitioned server, (logical and/or physical) partition boundaries are used to cordon the different partitions off from each other. Within the respective partitions, separate operating systems can be executed, which then run in parallel on the same server, using different hardware resources of the server system. Such partitioning is becoming more and more popular, e.g., as there is increasing use of bare metal cloud (as compared to virtual machine instances. A partitioned server can offer right-sized instances with better isolation than a virtual machine. Moreover, a partitionable server platform may reduce a blast radius of a failure, so that the crash of an operating system in one instance (i.e., partition) does not affect another.

However, even in partitioned servers, multiple partitions still share a common hardware platform, which include the system firmware (e.g., the Basic Input/Output System, BIOS) for platform configuration and SMI (System Management Interrupt)/SMM (System Management Mode) to handle RAS (Reliability, Availability, Serviceability) events and exceptions.

### BRIEF DESCRIPTION OF THE FIGURES

Some examples of apparatuses and/or methods will be described in the following by way of example only, and with reference to the accompanying figures, in which

FIG. 1a shows a schematic diagram of an example of a firmware apparatus or firmware device, and of a computer system comprising such a firmware apparatus or firmware device;

FIG. 1b shows flow chart of an example of a firmware method;

FIG. 2a shows a schematic diagram of an example of a processor, and of a computer system comprising such a processor;

FIG. 2b shows a flow chart of an example of a method for a processor;

FIG. 3 shows a schematic diagram of an example of a two-stage system firmware architecture for a partitioned platform;

FIG. 4 shows a schematic diagram of a firmware architecture for a two-stage system management mode;

FIGS. 5a and 5b show examples of a proposed hardware change to support a two-stage system management mode;

FIG. 6 shows a sequence diagram of an example of a System Management Mode (SMM)-II flow;

FIG. 7 shows a sequence diagram of an example of an SMM-I flow; and

FIG. 8 shows a sequence diagram of an example of SMM-II-instance system management interrupt redirection.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

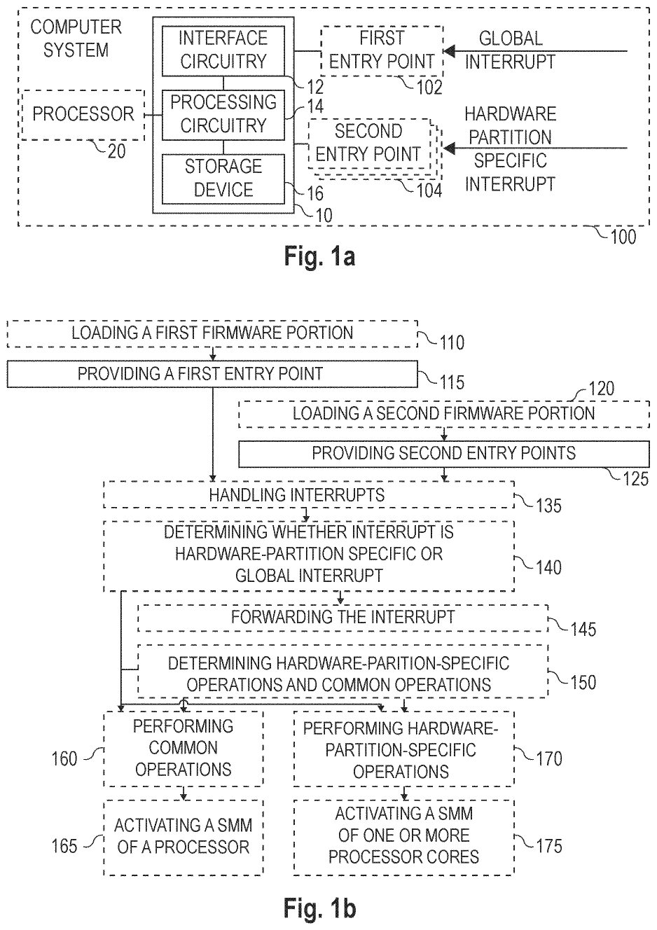

FIG. 1a shows a schematic diagram of an example of a firmware apparatus 10 or firmware device 10. FIG. 1a further shows an example of a computer system 100 comprising such a firmware apparatus 10 or firmware device 10 and a processor 20. The apparatus 10 comprises circuitry to provide the functionality of the apparatus 10. For example, the circuitry of the apparatus 10 may be configured to provide the functionality of the apparatus 10. For example, the apparatus 10 of FIGS. 1a and 1b comprises interface circuitry 12, processing circuitry 14 and (optional) storage circuitry 16. For example, the processing circuitry 14 may be implemented by the processor 20. Alternatively, the processing circuitry 14 may be at least partially separate from the processor 20. For example, the processing circuitry 14 may be coupled with the interface circuitry 12 and with the storage circuitry 16. For example, the processing circuitry 14 may provide the functionality of the apparatus, in conjunction with the interface circuitry 12 (for exchanging information, e.g., with other components inside or outside the computer system 100 comprising the apparatus or device 10) and the storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is to provide a first entry point 102 for handling global system interrupts. The processing circuitry 14 or means for processing 14 is to provide a plurality of second entry points 104 for handling hardware partition-specific system interrupts. The plurality of second entry points are based on a plurality of hardware partitions of the computer system.

In the present disclosure, the firmware apparatus 10 or firmware device 10 are closely linked to the system firmware (e.g., the Basic Input/Output System (BIOS) and/or Unified Extensible Firmware Interface (UEFI) of the computer system. For example, the firmware apparatus 10 or firmware device 10 may implement at least an aspect of the system firmware of the computer system. In other words, the system firmware may correspond to the firmware apparatus 10 or firmware device 10, or the system firmware may comprise the firmware apparatus 10 or firmware device 10.

FIG. 1b shows flow chart of an example of a corresponding firmware method for the computer system 100. The method comprises providing 115 the first entry point 102 for handling global system interrupts. The method comprises providing 125 the plurality of second entry points 104 for handling hardware partition-specific system interrupts. For example, the firmware method may be performed by a system firmware of the computer system, e.g., by the firmware apparatus or firmware device 10.

In the following, the functionality of the firmware apparatus 10, the firmware device 10, the firmware method and of a corresponding computer program is illustrated with respect to the firmware apparatus 10. Features introduced in connection with the apparatus 10 may likewise be included in the corresponding device 10, method and computer program.

Various examples of the present disclosure are based on the finding that, in partitioned computer systems, i.e., computer systems that are split into a plurality of mutually independent partitions, some events affect all of the partitions, while being only relevant for a subset of them. For example, in a partitioned computer system, the hardware devices (e.g., Graphics Processing Units, Artificial Intelligence Accelerators etc.) and the processor cores of the processor of the computer system may be assigned to different partitions of the computer system, e.g., four cores for each partition. A system management interrupt (SMI) originating from one of the hardware devices, e.g., from a hardware device being part of a first partition, might be only of relevance to the remaining hardware of the first partition, such as the processor cores being part of the first partition. Accordingly, the global system interrupts and the hardware partition-specific system interrupts discussed herein may be system management interrupts (SMIs). However, due to the nature of SMIs, in other systems, all of the processor cores are brought into System Management Mode (SMM), where the execution of computer programs on the processor cores is interrupted. As a result, processor cores of at least one second hardware partition are also brought into SMM, causing a disruption in the at least one second hardware partition as well.

In the proposed approach, such a scenario is avoided by distinguishing between system interrupts, and in particular SMIs, that are globally relevant (i.e., relevant for (all of) the hardware partitions), and system interrupts that are relevant for only one (or a subset of) the hardware partitions.

As is evident, the proposed approach applies to partitioned computer systems. In other words, the computer system is a partitioned computer system with a plurality of hardware partitions. For example, each hardware partition may comprise at least one processor core of the processor 20. For example, if the computer system comprises two or more processors, each hardware partition may comprise at least one processor core of at least one of the two or more processors. The computer system may comprise additional hardware devices, such as memory. For example, each hardware partition may comprise a portion of the memory of the computer system. For example, in addition to the at least one processor core and portion of memory, the hardware partitions may comprise one or more additional hardware device(s), such as GPUs, AI accelerators, Field-Programmable Gate Arrays (FPGAs) etc. Alternatively, or additionally, additional hardware device(s) may be shared among hardware partitions.

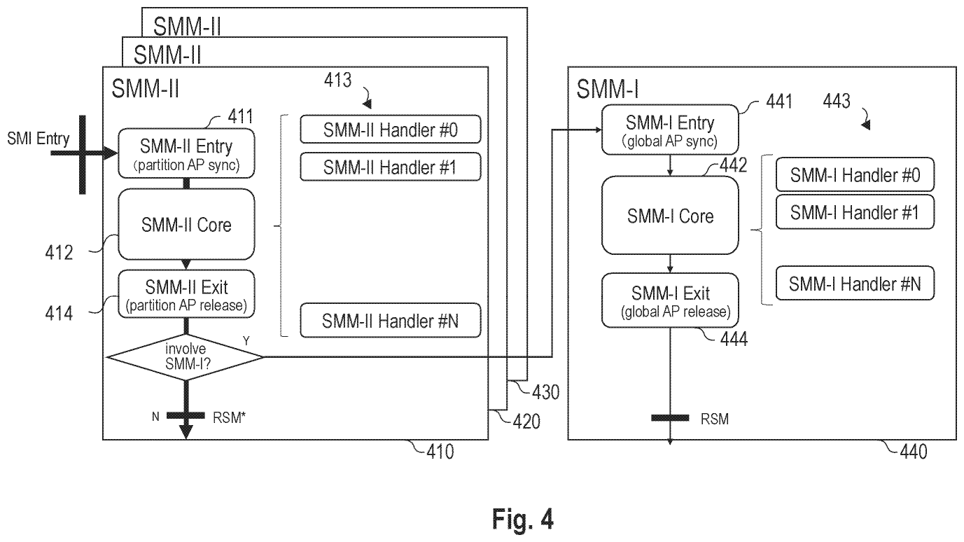

To support the differentiation between hardware partition-specific system interrupts and global system interrupts, two types of entry points for handling system interrupts are proposed—the first entry point 102 for handling global system interrupts, and the plurality of second entry points 104 for handling hardware partition-specific system interrupts. In the proposed approach, and as illustrated in FIG. 4, a separate second entry point may be provided for each hardware partition of the computer system. Accordingly, as further shown in FIG. 1b, the method may comprise providing 125 a separate second entry point for each hardware partition of the computer system. This way, the plurality of second entry points are based on the plurality of hardware partitions of the computer system, such that hardware partition-specific system interrupts only affect one of the hardware partition.

In the present context, and as further shown in FIG. 4, the entry points may correspond to interfaces (SMI Entry in FIG. 4). Once a system interrupt has been received via the interface, the respective processor core providing the entry point may switch into system management mode, process the system interrupt, and select a corresponding system interrupt handler. As shown in FIG. 4, a two-stage process may be used, where each of the system interrupts is first provided to one of the second entry points (provided by one of the instances of SMM-II in FIG. 4). If necessary, the system interrupt can be forwarded to the first entry point (provided by SMM-I in FIG. 4), e.g., if the system interrupt is a global interrupt, or if handling the hardware partition-specific interrupt comprises a global component.

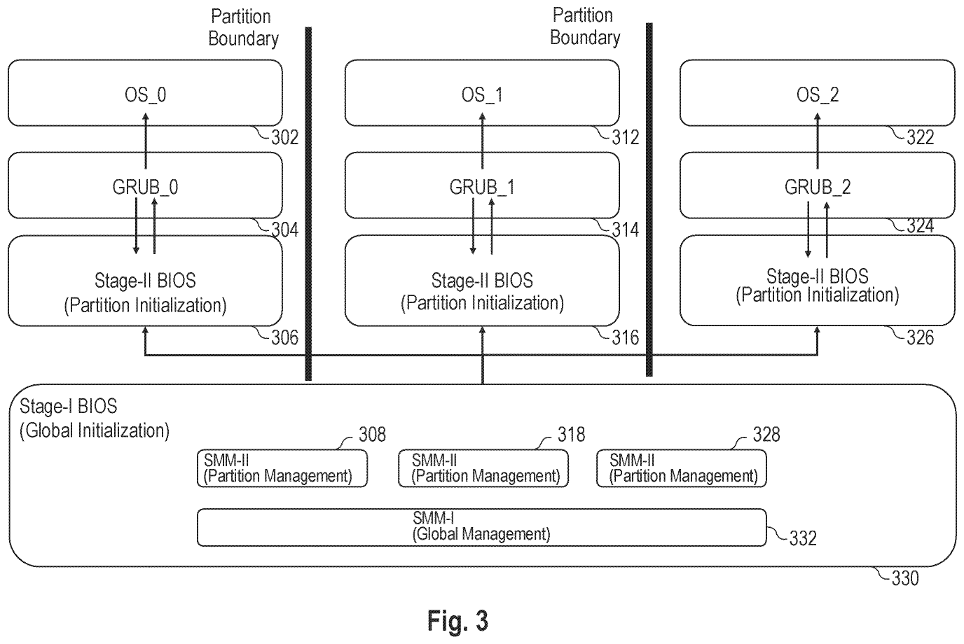

To further support the independent operation of the hardware partitions, not only the handling of the system interrupts, but also the system firmware (e.g., the BIOS and/or UEFI) may be implemented in two stages, with a first global stage and a plurality of second hardware partition-specific stages. An example is shown in FIG. 3, where the Stage-I BIOS 330 corresponds to the global stage and the Stage-II BIOS 306, 316, 326 correspond to the second hardware partition-specific stages. Thus, the processing circuitry may load a first system firmware portion (i.e., the global stage) and a plurality of second firmware portions (i.e., the hardware partition-specific stages). Accordingly, as further shown in FIG. 1b, the method may comprise loading 110 a first system firmware portion and loading 120 a plurality of second firmware portions. For example, the first system firmware portion may affect the plurality of hardware partitions and the plurality of second firmware portions may each affecting one of the plurality hardware partitions. In FIG. 3, both the first entry point (SMM-I 332) and the second entry points (SMM-II 308, 318, 328) are provided by the first firmware portion. Alternatively, the first entry point may be provided by the first firmware portion and the second entry point may be provided by the second firmware portions. Yet alternatively, the first and second entry points may be provided by the second firmware portions, e.g., by forwarding the global system interrupts obtained via the second entry points provided by the second firmware portions. However, not only an entry point may be provided for the system interrupts. The processing circuitry may further handle the interrupts obtained via the first entry point and via the second entry points. Accordingly, as further shown in FIG. 1b, the method may comprise handling 135 the interrupts obtained via the first entry point and via the second entry points. For example, as shown in FIG. 4, the firmware apparatus may comprise system interrupt handlers (SMM-II handlers 413 and SMM-I handlers 443 in FIG. 4) for handling the system interrupts. To select the appropriate interrupt handler, the firmware apparatus may first distinguish between global system interrupts and hardware partition-specific system interrupts. On the one hand, this can be done based on the entry point being used to obtain the respective interrupt. However, while the provision of the first and the second entry points can support making this determination, some ambiguity may remain (depending on implementation and/or entity raising the system interrupt). For example, in some implementations, all of the system interrupts may be obtained via one of the second entry points, with a system interrupt being forwarded to the first entry point if it is a global system interrupt. Additionally, or alternatively, both types of entry points may be exposed, with a system interrupt erroneously being provided to the “wrong” type of entry point. Therefore, the processing circuitry may determine, for an interrupt obtained via one of the second entry points, whether the interrupt is a hardware partition-specific system interrupt that is specifically relevant to the hardware partition associated with the second entry point or a global system interrupt that is commonly relevant for the computer system. The processing circuitry may forward the interrupt to the first entry point if the interrupt is a global system interrupt that is commonly relevant for the computer system. Accordingly, as further shown in FIG. 1b, the method may comprise determining 140, for an interrupt obtained via one of the second entry points, whether the interrupt is a hardware partition-specific system interrupt that is specifically relevant to the hardware partition associated with the second entry point or a global system interrupt that is commonly relevant for the computer system. The method may comprise forwarding 145 the interrupt to the first entry point if the interrupt is a global system interrupt that is commonly relevant for the computer system. Similarly, the processing circuitry may determine, for an interrupt obtained via the first entry point, whether the interrupt is a hardware partition-specific system interrupt that is specifically relevant to the hardware partition associated with a second entry point or a global system interrupt that is commonly relevant for the computer system. The processing circuitry may forward the interrupt to the respective second entry point if the interrupt is specifically relevant to a hardware partition associated with the second entry point. Accordingly, as further shown in FIG. 1b, the method may comprise determining 140, for an interrupt obtained via the first entry point, whether the interrupt is a hardware partition-specific system interrupt that is specifically relevant to the hardware partition associated with the second entry point or a global system interrupt that is commonly relevant for the computer system. The method may comprise forwarding 145 the interrupt to the respective second entry point if the interrupt is specifically relevant to a hardware partition associated with the second entry point.

Once the system interrupts received via the respective entry points have been ascertained to relevant (or been forwarded to the relevant entry point), they are handled by the instruction handlers associated with said entry point. For example, the processing circuitry may perform, based on a global system interrupt obtained via the first entry point, one or more common operations in a context of the first entry point, with the context of the first entry point affecting the plurality of hardware partitions. Accordingly, as further shown in FIG. 1b, the method may comprise performing 160, based on a global system interrupt obtained via the first entry point, the one or more common operations in the context of the first entry point. For example, the one or more common operations may be performed as part of an interrupt handler associated with the first entry point, i.e., as part of a global interrupt handler (SMM-I handler 443 in FIG. 4, for example). These operations are performed in the context of the first entry point, which is the global context, affecting all of the hardware partitions alike (including bringing (all of) the cores of the processor into system management mode). In other words, the context of the first entry point affects the plurality of hardware partitions.

Hardware partition-specific system interrupts, on the other hand, are handled in a way that (only) affect the hardware partition for which they are relevant. In other words, the processing circuitry may perform, based on a hardware partition-specific system interrupt obtained via a second entry point, one or more hardware partition-specific operations in a context of the second entry point, the context of the second entry point affecting the hardware partition associated with the second entry point. Accordingly, as further shown in FIG. 1b, the method may comprise performing 170, based on a hardware partition-specific system interrupt obtained via a second entry point, one or more hardware partition-specific operations in the context of the second entry point. For example, the one or more common operations may be performed as part of an interrupt handler associated with the respective second entry point, i.e., as part of a hardware partition-specific interrupt handler (SMM-II handler 413 in FIG. 4, for example). These operations are performed in the context of the respective second entry point, which is a hardware partition-specific context, affecting only the processor cores of that hardware partition. In other words, the context of the second entry point affects the hardware partition associated with the second entry point.

In some cases, a system interrupt may require handling both in the global context and the hardware partition-specific context. For example, some system interrupts may comprise a first component that is globally relevant for the various hardware partitions of the computer system, and a second component that is only relevant for one of the hardware partitions. In this case, some of the operations may be performed in the context of the first entry point, and some of the operations may be performed in the context of the second entry point. For example, the processing circuitry determine, for an interrupt obtained via the first or via a second entry point, one or more hardware partition-specific operations (i.e., the second component) and one or more common operations (i.e., the first component) to be performed. The processing circuitry may perform the one or more hardware partition-specific operations in the context of the second entry point and perform the one or more common operations in the context of the first entry point. Accordingly, as further shown in FIG. 1b, the method may comprise determining 150, for an interrupt obtained via the first or via a second entry point, one or more hardware partition-specific operations and one or more common operations to be performed. The method may comprise performing 170 the one or more hardware partition-specific operations in the context of the second entry point and performing 160 the one or more common operations in the context of the first entry point. In general, either the hardware partition-specific operation(s), or the common operation(s) may be performed first. Depending on the order, handling the system interrupt may be started via the first entry point or via the second sentry point. For example, the system interrupt may first be handled via the first entry point, by performing the one or more common operations, and then forwarded to the second entry point(s), to perform the one or more hardware partition-specific operations. In this case, the second entry point (SMM-II) is used as bottom half of the first entry point (SMM-I). This may allow spreading the one or more hardware partition-specific operations to more than one hardware partition after performing the one or more common operations. Alternatively, the system interrupt may first be handled via the respective second entry point, by performing the one or more hardware partition-specific operations, and then forwarding to the first entry point, to perform the one or more hardware partition-specific operations. In this case, the first entry point (SMM-I) is used as bottom half of the respective second entry point (SMM-II).

As outlined above, one of the reasons behind using the two-stage approach is the performance overhead caused by all of the cores entering the system management mode. In the present approach, this performance overhead may be reduced by only activating the system management mode for cores for which the respective system interrupt (or operations thereof) are relevant. Accordingly, the processing circuitry may activate, for one or more operations to be performed in the context of the first entry point (e.g., the interrupt handler being run in the context of the first entry point),, a system management mode of the (entire) processor of the computer system. The processing circuitry may activate, for one or more operations to be performed in the context of the second entry point (e.g., the interrupt handler being run in the context of the respective second entry point), a system management mode of one or more processor cores of the processor, the one or more processor cores being part of a hardware partition associated with the second entry point. Accordingly, as further shown in FIG. 1b, the method may comprise activating 165, for one or more operations to be performed in the context of the first entry point, the system management mode of the processor of the computer system. The method may comprise activating 175, for the one or more operations to be per-formed in the context of the second entry point, the system management mode of one or more processor cores of the processor, the one or more processor cores being part of a hardware partition associated with the second entry point.

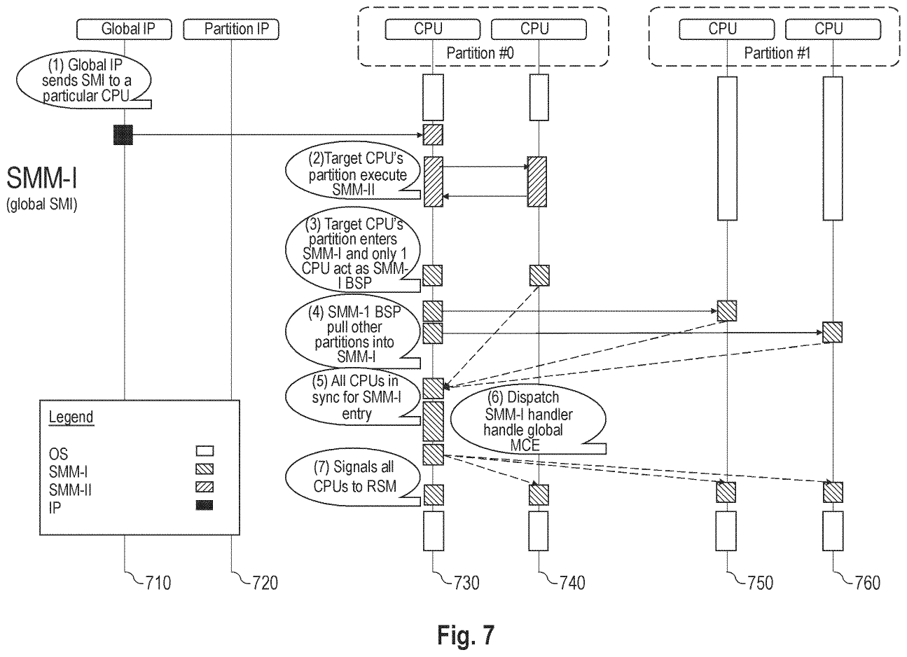

Depending on the scenario, and in particular depending on which processor core initially handles the system interrupt, some additional communication may be necessary to activate the system management mode. For example, if a global system interrupt is handled (via the first entry point or via one of the second entry points) by one of the processor cores, which core may notify the other processor cores to enter the system management mode. An example for this is shown in FIG. 7, for example, where CPU core 730 pulls both the CPU core 740 of the same partition and also the CPU cores 750, 760 of the other partition into system management mode. For example, the processing circuitry may, when the interrupt is initially handled by a processor core of the processor, notify, for one or more operations to be performed in the context of the first entry point (i.e., in the global context/SMM-I), the other processor cores of the processors to activate the system management mode. Accordingly, the method may comprise notifying, for one or more operations to be performed in the context of the first entry point, the other processor cores of the processors to activate the system management mode. In case the operations are to be performed in the context of a second entry point, only the other processor cores of the same hardware partition, or, if the processor core initially handling the system interrupt is not part of the hardware partition associated with the second entry point, the processor cores of the hardware partition being affected, might be notified. In other words, the processing circuitry may notify, for one or more operations to be performed in the context of the second entry point, the one or more processor cores being part of a hardware partition associated with the second entry point, to activate the system management mode. Accordingly, the method may comprise notifying, for one or more operations to be performed in the context of the second entry point, the one or more processor cores being part of a hardware partition associated with the second entry point, to activate the system management mode. Once in the system management mode, the processor core(s) may handle the system interrupt appropriately.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a server computer system, i.e., a computer system being used to serve functionality, or a workstation computer system. In particular, the computer system may be a partitioned computer system, i.e., a computer system with a plurality of mutually separated hardware partitions.

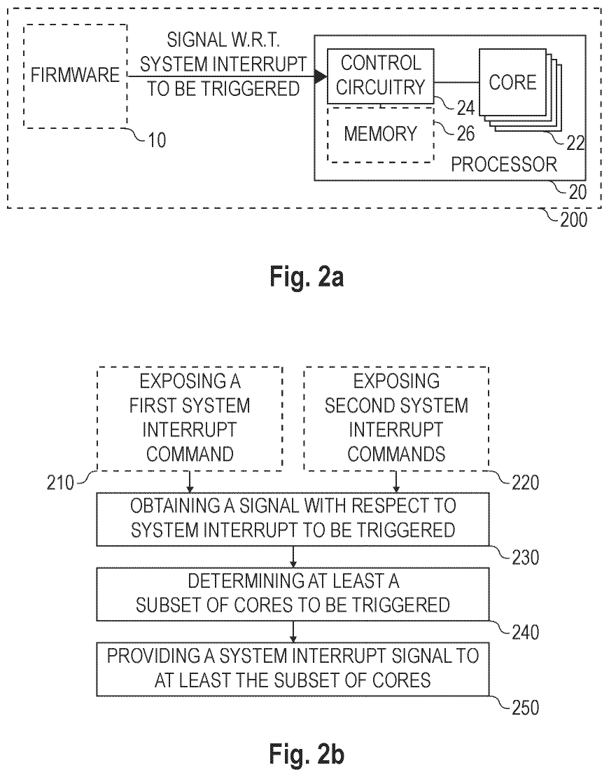

More details and aspects of the firmware apparatus 10, firmware device 10, firmware method, corresponding computer program and computer system are mentioned in connection with the proposed approach, or one or more examples described above or below (e.g. FIG. 2a to 8). The firmware apparatus 10, firmware device 10, firmware method, corresponding computer program and computer system may comprise one or more additional optional features corresponding to one or more aspects of the proposed approach, or one or more examples described above or below.

FIG. 2a shows a schematic diagram of an example of a processor 20, and of a computer system 200 comprising such a processor 20. The processor 20 comprises circuitry for providing the functionality of the processor 20. In particular, the processor comprises processor cores 22 and additional circuitry for supporting the processor cores. In particular, the processor comprises control circuitry (or means for controlling) 24, which is coupled to the processor cores 22. In the present context, the control circuitry 24 or means for controlling 24 is used to control the distribution of system interrupts to the processor cores 22 of the processor cores-the control circuitry 24 or means for controlling 24 acts as redistribution layer for redistributing system interrupts to the respective cores. This redistribution layer is used to avoid system interrupts stalling all of the processor cores, regardless of whether the system interrupt is relevant for said core. This is, in particular, relevant in partitioned computer systems, where the cores of the computer system are associated with different partitions of the computer system. In various examples of the present disclosure, the functionality of the control circuitry 24 or means for controlling 24 may be provided by the control circuitry 24 or means for controlling 24 executing machine-readable instructions, e.g., program code or microcode. Accordingly, any feature ascribed to the control circuitry 24 or means for control circuitry 24 may be defined by one or more instructions of a plurality of machine-readable instructions. The processor may comprise the machine-readable instructions, e.g., within a (non-volatile) memory 26 of the processor. For example, the memory 26, which may be a flash-based memory, may be coupled with the control circuitry 24 or means for controlling 24 and/or with the processor cores 22.

The control circuitry 24 or means for controlling 24 is to obtain a signal with respect to a system interrupt to be triggered. The control circuitry 24 or means for controlling 24 is to determine, based on at least one of a source of the signal and a content of the signal, at least a subset of the plurality of cores that is to be notified of the system interrupt to be triggered. The control circuitry 24 or means for controlling 24 is to provide a system interrupt signal to at least the subset of the cores 22.

FIG. 2b shows a flow chart of an example of a corresponding method for the processor 20. The method comprises obtaining 230 the signal with respect to a system interrupt to be triggered. The method comprises determining 240, based on at least one of the source of the signal and the content of the signal, at least a subset of the plurality of cores that is to be notified of the system interrupt to be triggered. The method comprises providing 250 the system interrupt signal to at least the subset of the cores 22.

In the following, the functionality of the processor 20, the method and of corresponding computer program comprising the machine-readable instructions is illustrated with respect to the processor 20. Features introduced in connection with the processor 20 may likewise be included in the corresponding method and computer program.

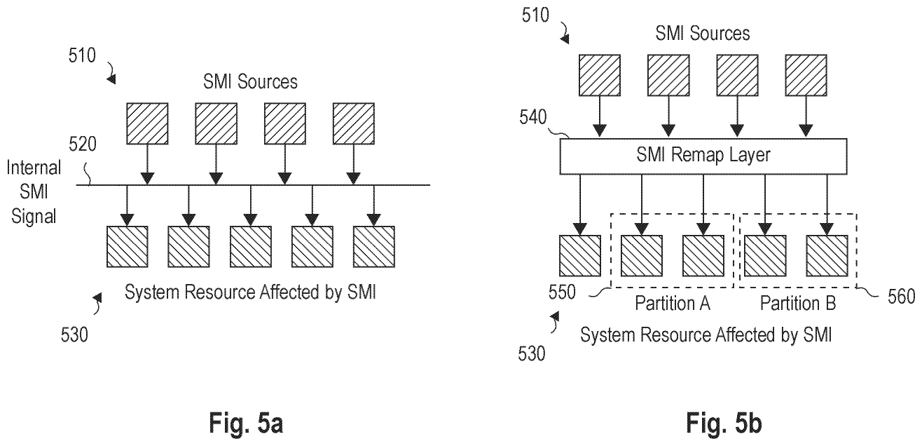

In many processors, the handling of system interrupts, such as SMIs, automatically involves all cores of the processor. The reason is shown in FIG. 5a—when one of the SMI sources 510 sends an SMI, the SMI is distributed, via a shared internal SMI signal, to the system resources 530 affected by the SMI. This generally includes (all of) the processor cores of the processor. In the processor proposed in the context of FIGS. 2a, 2b and 5b, this automatic sharing is replaced by a redistribution/remapping layer, which is used to target the system interrupts at specific system resources, such as specific hardware partitions in case of a hardware partition-specific system interrupt. In case the system interrupt is relevant for all of the processor cores, it can still be provided to all of the processor cores. This way, receiving a system interrupt does not automatically stall all of the processor cores. While the interrupt handling proposed in connection with FIGS. 1a and/or 1b can work with such a processor (by quickly leaving the SMM in processor cores that are not affected by a hardware partition-specific system interrupt), the processor design shown in connection with FIGS. 2a, 2b and 5b can further improve efficiency, by avoiding unaffected system resources entering the system management mode in the first place.

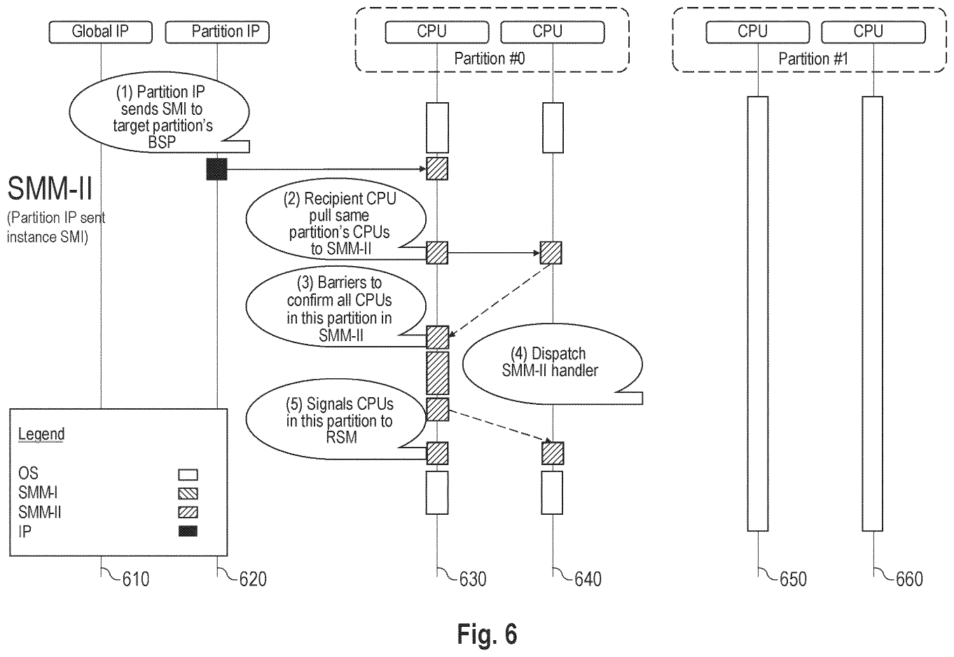

The proposed redistribution/remapping approach controls, which of the processor cores receive a system interrupt (i.e., the system interrupt signal). To achieve this, an incoming signal or event (the signal with respect to a system interrupt to be triggered) is processed to determine, whether it is globally relevant (and thus to be provided to any or all of the processor cores), or whether it is only relevant for a hardware partition (and thus only to be provided to one of more processor cores included in that hardware partition. Thus, the processing circuitry obtains (e.g., receives) the signal with respect to a system interrupt to be triggered. For example, the signal with respect to the system interrupt to be triggered may be a system interrupt (event) or signal interrupt signal, or information on an event triggering a system interrupt. As shown in FIGS. 5a-5b, the signal with respect to the system interrupt to be triggered may be obtained from an SMI source, such as a hardware device (denoted “IP” in FIGS. 6 to 8, which stands for intellectual property, a term used for hardware devices that are sold as intellectual property, e.g., to be implemented by an original equipment manufacturer) or by an operating system or application program.

The processing circuitry then determines, based on at least one of a source of the signal and a content of the signal, at least a subset of the plurality of cores that is to be notified of the system interrupt to be triggered. This may be a two-stage process—first, it may be determined whether a global system interrupt is to be issued, or whether a hardware partition-specific interrupt is to be issued. In other words, the control circuitry may be distinguish between global system interrupts to be triggered for the plurality of processor cores and hardware partition-specific interrupts to be triggered for a subset of the processor cores. Then, in the latter case, a subset of cores may be selected based on a hardware partition associated with the hardware partition-specific system interrupt.

To determine, whether a global system interrupt is to be issued or whether a hardware partition-specific interrupt is to be issued, both the source and the content of the signal with respect to the system interrupt to be triggered may be of relevance. For example, some signals with respect to a system interrupt to be triggered may be globally relevant according to the system interrupt to be triggered, and thus the content of the signal, as some system interrupts are inherently global. Moreover, while, in hardware partitioning, large portions of the hardware resources of a computer system are assigned exclusively to one of the hardware portions, some of the hardware resources may be shared among different hardware partitions (and may thus trigger global system interrupts). Accordingly, the determination of at least the subset of the plurality of cores may be based on whether the source or content of the signal relates to a global resource that is used by multiple hardware partitions or to a local resource that is used (exclusively) by one of the hardware partitions. More generally, the determination of at least the subset of the plurality of cores may be based on a hardware partitioning of at least one of the processor and a computer system 100 hosting the processor. While this is also relevant for distinguishing between global system interrupts and hardware partition-specific system interrupts, its relevance is even higher for selecting the appropriate processor core(s) in the latter case. For this purpose, a mapping between hardware resources (as source of the signal with respect to the system interrupt to be triggered, and as destination of the system interrupt signal) and hardware partitions may be used. In other words, a mapping may be used for determining, based on the source of the signal with respect to the system interrupt to be triggered, whether the signal with respect to the system interrupt to be triggered is to trigger a global system interrupt or a hardware partition-specific system interrupt, and, in the latter case, in which of the hardware partitions is the destination of the hardware partition-specific system interrupt signal. Accordingly, the processor may comprise a memory 26 with a mapping between resources and hardware partitions. For example, the mapping may comprise, on the one hand, for each hardware partition and also for the global scope, information on a plurality of sources that are potential sources of signals with respect to a system interrupt to be triggered, and, on the other hand, for each hardware partition and optionally also for the global scope, information on processor core(s) to be included in the subset of processor cores.

To facilitate distinguishing between global system interrupts to be triggered for the plurality of processor cores and hardware partition-specific interrupts to be triggered for a subset of the processor cores, different interfaces may be provided for the two cases. Similar to the approach used in connection with FIGS. 1a and/or 1b, two types of commands may be exposed—a first command for issuing global system interrupts, and a plurality of second commands for issuing hardware partition-specific interrupts. In other words, the control circuitry may to expose a first system interrupt command for global system interrupts and a plurality of second system interrupt commands for hardware partition-specific interrupts. Accordingly, as further shown in FIG. 2b, the method may comprise exposing 210 the first system interrupt command for global system interrupts and exposing 220 the plurality of second system interrupt commands for hardware partition-specific interrupts. For example, a separate second system interrupt command may be exposed for each hardware partition., with a separate second system interrupt command being exposed for each hardware partition. In connection with FIG. 5b, these different commands are also denoted SMI_CMD (for the first system interrupt command) and per-partition SMI_CMD (for the second system interrupt commands).

Depending on the type of system interrupt (global or hardware partition-specific) and, in the latter case, the hardware partition it is relevant for, the system interrupt signal is then provided (only) to the subset of cores 22 determined previously. For example, the system interrupt signal may be provided to one core of the subset of cores (with the core being signaled drawing the other cores, for which the system interrupt is relevant, into SMM), to all of the cores of the subset of cores, or to one core per hardware partition represented in the subset.

For example, the processor 20 may implement multi-core hardware circuitry such as a CPU, a DSP, a GPU, an XPU, etc. Although it may include any number of example cores 22 (e.g., 1 core), the processor 20 of this example is a multi-core semiconductor device including N cores. The cores 22 of the processor 20 may operate independently or may cooperate to execute machine readable instructions. For example, machine code corresponding to a firmware program, an embedded software program, or a software program may be executed by one of the cores 22 or may be executed by multiple ones of the cores 22 at the same or different times. In some examples, the machine code corresponding to the firmware program, the embedded software program, or the software program is split into threads and executed in parallel by two or more of the cores 22.

The cores 22 may communicate by an example bus. In some examples, the bus may implement a communication bus to effectuate communication associated with one(s) of the cores 22. The cores 22 may obtain data, instructions, and/or signals from one or more external devices, e.g., via interface circuitry. The cores 22 may output data, instructions, and/or signals to the one or more external devices by the interface circuitry. Although the cores 22 of this example include example local memory (e.g., Level 1 (L1) cache that may be split into an L1 data cache and an L1 instruction cache), the processor 20 may also include example shared memory that may be shared by the cores (e.g., Level 2 (L2 cache)) for high-speed access to data and/or instructions. Data and/or instructions may be transferred (e.g., shared) by writing to and/or reading from the shared memory.

Each core 22 may be referred to as a CPU, DSP, GPU, etc., or any other type of hardware circuitry. Each core 22 may include control unit circuitry, arithmetic, and logic (AL) circuitry (sometimes referred to as an ALU), a plurality of registers, the L1 cache, and an example bus. Other structures may be present. For example, each core 22 may include vector unit circuitry, single instruction multiple data (SIMD) unit circuitry, load/store unit (LSU) circuitry, branch/jump unit circuitry, floating-point unit (FPU) circuitry, etc. The control unit circuitry, which may include the control circuitry 24, may include semiconductor-based circuits structured to control (e.g., coordinate) data movement within the corresponding core 22. The AL circuitry may include semiconductor-based circuits structured to perform one or more mathematic and/or logic operations on the data within the corresponding core 22. In some examples, the AL circuitry may be referred to as an Arithmetic Logic Unit (ALU). The registers are semiconductor-based structures to store data and/or instructions such as results of one or more of the operations performed by the AL circuitry of the corresponding core 22.

For example, the control circuitry 24 or means for controlling 24 may be implemented using one or more processing units, one or more processing devices, any means for processing, such as a programmable hardware component being operable with accordingly adapted software. In other words, the described function of the control circuitry 24 or means for controlling 24 may as well be implemented in software, which is then executed on one or more programmable hardware components. Such hardware components may comprise a micro-controller, etc.

More details and aspects of the processor 20, method and computer system 200 are mentioned in connection with the proposed approach, or one or more examples described above or below (e.g., FIG. 1a to 1b, 3 to 8). The processor 20, method and computer system 200 may comprise one or more additional optional features corresponding to one or more aspects of the proposed approach, or one or more examples described above or below.

Various example of the present disclosure relate to a two-stage System Management Mode (SMM) system firmware (e.g., BIOS) architecture for a partitioned server platform.

The System Management Mode (SMM) is a special-purpose operating mode provided for handling system-wide functions like power management, system hardware control, or proprietary OEM-designed code. It is intended for use by system firmware, not by application software or general-purpose systems software. The SMM offers a distinct and easily isolated processor environment that operates transparently to the operating system or executive and software applications.

A System Management Interrupt (SMI) is an interrupt that is used to activate the SMM. For example, to enter SMM, an SMI may be signaled through the SMI #pin on the processor or through an SMI message received through the APIC (Advanced Programmable Interrupt Controller) bus. The SMI is a non-maskable external interrupt (NMI) that operates independently from the processor's interrupt-and exception-handling mechanism and the local APIC. The SMI takes precedence over an NMI and a maskable interrupt. SMM is non-reentrant; that is, the SMI is disabled while the processor is in SMM.

In partitioned servers, the consistent use of a global SMI/SMM may be considered less than ideal, as the SMI handler involves all cores of the processor. Thus, a SMI for one partition may affect other partitions. With respect to SMM, no partitioning is done in other systems. The present disclosure proposes a two-stage SMM architecture, along with a two-stage system firmware (e.g., BIOS) to address global SMM overhead that is, in particular, relevant in partitionable server platforms.

In other approaches, a partitional system may be implemented with fully isolated partitions (such as one CPU socket as one partition in a multi-socket server). This is costly and not scalable to support small partitions, and in particular sub-socket partition.

The proposed approach provides a two-stage SMM in a two-stage BIOS flow. In the proposed approach, the SMM is separated into a global SMM (in the following denoted SMM-I, providing the context for the first entry point introduced in connection with FIGS. 1a to 1b) and partition SMM (in the following denoted SMM-II, providing the context for the second entry point introduced in connection with FIGS. 1a to 1b). A single SMM-I is bound to the global SMI domain, which is affiliated with a Stage-IBIOS. Multiple SMM-IIs are bound to partition SMI domains (i.e., related to the plurality of hardware partitions), one for each partition. SMM-II is conceptually affiliated with the Stage-II BIOS.

The following SMM-I/SMM-II flows are proposed to reduce the impact of SMM-I, and to avoid the SMI-II handling introducing a global impact. Interactions between SMM-I/II and among multiple SMM-IIs are supported, so that the complexity of partitioned hardware can be handled.

In the present disclosure, a two-Stage SMM approach is proposed, comprising SMM-I (i.e., global SMM) and SMM-II (partition SMM). SMM-I is used to handle global exception events. When the system is in SMM-I, all cores are in SMM mode. SMM-I may be designed such, that the usage and residence in SMM-I is reduced or minimized. SMM-II is used to handle partition-specific exception events. SMM-II is hardware partition-specific and might only affect cores in that partition. For example, different partition may independently enter or exit SMM-II.

In a hardware partitionable system, a two-stage system firmware (e.g., BIOS) is produced. Stage-I BIOS initialize the whole platform, while Stage-II BIOS is partition-specific, and only initializes the partition.

In the following, an example of the proposed two-stage BIOS is given-as reference on how SMM-I/II fits into BIOS (or more generally, system firmware). A two-Stage BIOS is one possible architecture form for the partitioned platform and is an example bearing architecture for the two-stage SMM. In the two-stage BIOS, the BIOS is divided into 2 stages. A single Stage-I BIOS is used to perform global hardware initialization and creation of contexts of multiple partitions. Multiple Stage-II BIOS, one for each partition, are used to perform partition-specific initialization, and especially OS execution environment creation, include UEFI system table setting up and OS loading. In the example provided herein. stage-II BIOS does not provide SMM capability, instead, SMM-IIs are initially setup by Stage-I BIOS altogether with SMM-I.

FIG. 3 shows a schematic diagram of an example of a two-stage system firmware (e.g., BIOS) architecture for a partitioned platform. In the context of the present disclosure, the BIOS is used as an example for the system firmware. Alternatively, instead of the BIOS, other examples of system firmware, such as the Unified Extensible Firmware Interface (UEFI) or core-boot, may be used.

In FIG. 3, global initialization is done by the Stage-I BIOS 330, which comprises a component 332 for SMM-I (global management) and multiple components 308, 318, 328 SMM-II (partition management). On top of the Stage-I BIOS, three separate Stage-II BIOS (306, 316, 326) are used (for partition initialization), one for each hardware partition. On top of the respective Stage-II BIOS, a boot loader (Grand Unified Bootloader, GRUB, 304, 314, 316) is loaded, which is used to start the respective operation system (OS, 302, 312, 322). Between the partitions, partition boundaries are shown in FIG. 3.

Please note that, in the example implementation shown in FIG. 3, both SMM-I/II are setup by Stage-I BIOS and running in SMM mode, although SMM-II is conceptually used for partition-specific logic. This is an implementation choice based on the SMM hardware being used, where the SMM state is global. In this case, SMM-I/II are only logically separate. However, in hardware supporting a partition-specific SMM stage, such as in the processor shown in connection with FIG. 2a, the SMM-II mode may be provided by the Stage-II BIOS. In various examples, some events may be handled by global SMI and some events may be handled by a hardware partition-specific SMI.

The proposed technology enables effective SMI handling for partitionable server platforms, which are a good candidate in the bare metal cloud. The technology can cover different partitioning strategies (physical or logical), e.g., as long as there are global and partition system hardware domains. However, this technology is not limited to the server segment. In embedded devices, where one SoC is partitioned to run a Real-Time Operating System (RTOS) and a rich OS, the same approach can be used.

As shown in FIG. 3, SMM-I and SMM-IIs may be setup by the Stage-I BIOS and both running in SMM mode. SMM modules may be implemented as PE-COFF (Portable Executable-Common Object File Format) or ELF (Executable and Linking Format) images, containing code and data segments. SMM modules may be flatly laid out in SMRR (System Management Range Register) protected DRAM (Dynamic Random Access Memory) ranges. In some examples, multiple SMM-IIs (and even together with SMM-I) may share the same code segments, but use independent data segments, to save the memory resources being used.

FIG. 4 shows a schematic diagram of a firmware architecture for a two-stage system management mode. For example, systems with the proposed two-stage SMM may have one SMM-I module 440 and multiple SMM-II modules 410, 420, 430. For example, the SMM-IIs may include an SMM-II entry 411 (for partition Application Processor, AP, sync), an SMM-II core 412 (with SMM-II handlers 413 0 . . . N), and an SMM-II Exit 414 (with partition AP release). After the SMM-II Exit 414, a determination is made on whether SMM-I is to be involved. If yes, SMM-I entry 441 (with global AP sync) of SMM-I 440 is called, followed by SMM-I Core 442 (with SMM-I handlers 443 0 . . . N), followed by SMM-I Exit (with global AP release). Once the respective SMM is exited, a RSM (Resume from SMM) command may be issued.

There are multiple ways SMM-I and SMM-II can be invoked. For example, a partition-specific exception may trigger SMI. In this case, the partition may enter SMM-II (410-430), and then exit SMM-II. Alternatively, the partition may enter SMM-II (410-43), and SMM-II may be escalated to system-wide SMM-I 440, followed by the system exiting SMI. If a global exception triggers a SMI, the system may enter SMM-I 440, and then exit SMM-I. Alternatively, the system may enter SMM-I 440, finishes handling of global events, and downgrade it to one or several SMM-II (410-420). Later, the partition may enter SMM-II to deal with the remaining processing.

To support two-stage SMM, the CPU (Central Processing Unit) hardware may be modified. FIGS. 5a and 5b show examples of a proposed hardware change to support a two-stage SMM. In FIG. 5a, the implementation used in other systems is shown. SMI sources 510 contribute to one (single) SMI signal 520, which affects all of the system resources 530. FIG. 5b shows a schematic diagram of an example of the proposed hardware to support the two-stage SMM. Instead of a single internal SMI signal, a SMI remap layer 540 is introduced, which is used to map the SMIs to different system resources, e.g., system resources of one of the hardware partitions 550, 560. In other words, instead of a single bus, a system may implement a SMI remap layer 540 to map different sources of events to corresponding receivers 530. The global SMI sources may affect all resources 530, while partition-specific events may affect only resources in corresponding modules/partitions. The implementation of SMI Remap Layer processor-specific. It may include one or more of the following functionalities. It may include event status and mask registers for (all of) the SMI sources. It may include a list of global SMI sources. It may include a mapping table between partition-specific SMI sources and affected partitions. It may include a mapping table between resources and partitions. It may include information on a per-partition SMI status and mask register.

In some examples, a per-partition SMI command (SMI_CMD) may be supported. For example, the OS may trigger an SMI synchronously by writing to SMI_CMD, which is an address (usually 0xB2 port Input/Output) passed by ACPI table. In some implementations, SMI_CMD is provided by the platform power management controller (PMC). For partition SMM, SMI_CMD may be implemented in a per-partition-way.

In the following, various examples of an SMM-I/SMM-II entry/exit flow are given.

In a first example, shown in FIG. 6, an SMM-II entry/exit without escalation to SMM-I is shown. In this flow, the CPU's SMI handler is configured in such a way that, at SMI entry, SMM-II of the partition the SMI belongs to is invoked first. At SMM-II entry, SMM-II BSP (Board Support Package) only pulls the same-partition CPUs into SMM. Subsequently, SMM-II handlers are dispatched. SMM-II handlers should only deal with the partition-specific operations. After the SMM-II dispatch loop completes, if at least one SMM-II handler is effectively executed, CPUs exit SMM-II and return to bare metal OS instance.

FIG. 6 shows a sequence diagram of an example of an SMM-II flow, where a partition-owned IP (Intellectual Property, a term used for custom logic modules) 620 sends partition SMI. FIG. 6 shows Global IP 610, Partition IP 620, two CPU cores 630, 640 of partition 0 and two CPU cores 650, 660 of partition 1. At (1), Partition IP 620 sends SMI to target partition's BSP. At (2), recipient CPU (core) 630 pulls the CPU cores 630, 640 of the same partition (0) to SMM-II. At (3), barriers are used to confirm all CPUs in this partition are in SMM-II. At (4), the SMM-II handler is dispatched. At (5), the CPU cores are signaled to RSM.

In a second example, SMM-II escalation to SMM-I is shown. In this example, first, SMM-II is executed on the CPU cores of the partition first. After the SMM-II dispatch loop completes, if no SMM-II handler has effectively been executed, that means the SMI event needs global handling. In this case, the SMM-II CPU cores transition to SMM-I entry. Also, if a flag is explicitly set to proceed to SMM-I, SMM-II CPU cores transition to SMM-I entry. At SMM-I entry, only one CPU might take the SMM-I BSP role (by some arbitration mechanism, e.g. by taking a global semaphore). Other CPUs initially coming from SMM-II may take the SMM-I AP role and park. The SMM-I BSP may further send the SMI to other partitions'CPUs to pull them down into SMM. For CPUs pulled down from other partitions, they may come to their SMM-II first with nothing to do, eventually transition into SMM-I and take SMM-I AP roles and park. Another similar case is multiple SMM-IIs entering SMM-I simultaneously. Still, only one CPU (core) may take the SMM-I BSP role and other CPUs (i.e., CPU cores) may take the SMM-I AP role and park. Subsequently, SMM-I handlers are dispatched. They process global SMM events. Finally, all CPUs (CPU cores) quit SMM and resume OS execution.

FIG. 7 shows a sequence diagram of an example of an SMM-I flow, where a global IP sends a global SMI. FIG. 7 shows the Global IP 710, Partition IP 720, CPU cores 730, 740 of partition 0, and CPU cores 750, 760 of partition 1. At (1), Global IP 710 sends a SMI to a particular CPU 730. At (2), the target CPU's partition executes SMM-II. At (3), the target CPU's partition enters SMM-I and only one CPU acts as SMM-I BSP. At (4), the SMM-I BSP pulls other partitions (CPU cores 750, 760 of partition 1) into SMM-I. At (5), all CPU cores are in sync for SMM-I entry. At (6), CPU 740 of partition 0 dispatches SMM-I handler to handle a global MCE (Machine Check Exception). At (7), CPU core 730 signals all CPU cores to RSM.

In a third example, SMM-I uses SMM-II as bottom half (SMM-I first). Various examples of the architecture allow some SMI events to be handled in global scope first as top-half quickly by SMM-I, and then continue to be further handled by a specific partition by its SMM-II as bottom-half, which takes extra latency. For this logic, at SMM-I completion, one selected CPU of the target partition may return to the SMM-II entry point while other CPUs quit SMM. The selected CPU may coordinate SMM-II flow for its partition as bottom-half further. This model is suitable for complex semi-global SMM events. Compared to be fully handled in SMM-I, it reduces the overall performance impacts of irrelative partitions.

In a fourth example, cross-SMM-II messaging/redirection is performed. For example, SMM-II of one partition may send an SMI to another partition to request the destination partition to execute SMM-II. This corresponds to a case where some IP's failure domain is partition-specific but not partition-aware. Instead of sending the SMI directly to the target partition, it can send the SMI to a default CPU and that CPU's SMM-II may find the correct target partition and does the redirection. Note that, ideally, the partition IP may be partition aware, i.e., the IP's failure domain is partition-specific, and it can accurately issue SMI to CPUs (CPU cores) in its partition. The two-stage SMM architecture can work with both ideal and unideal partition IP models, and thus with a reduced or minimal hardware dependency.

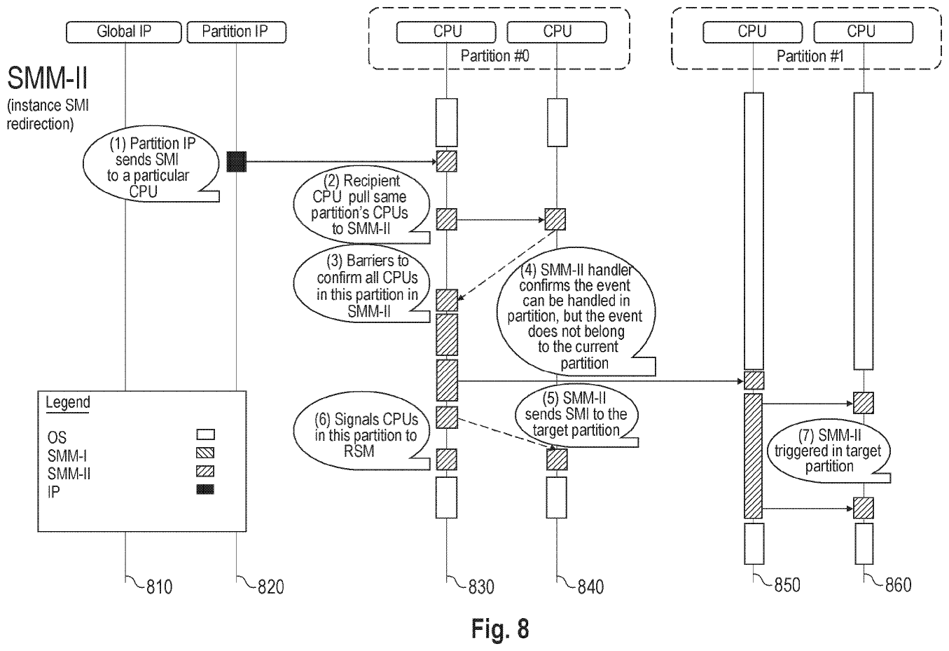

FIG. 8 shows a sequence diagram of an example of SMM-II instance SMI redirection. FIG. 8 shows Global IP 810, Partition IP 820, CPU cores 830, 840 of partition 0 and CPU cores 850, 860 of partition 1. At (1), a partition IP 820 sends a SMI to a particular CPU 830 (of partition 0). At (2), the recipient CPU 830 pulls the same partition's CPU cores 830, 840 to SMM-II. At (3), barriers are used to confirm all CPU cores in this partition are in SMM-II. At (4), the SMM-II handler (executed by CPU core 830) confirms the event can be handled in some partition, but the event does not belong to its partition. At (5), SMM-II sends the SMI to target partition 1. At (6), CPU core 830 signals CPU cores 830, 840 in this partition to RSM. At (7), SMM-II is triggered in the target partition (in CPU core 850, 860).

Various example of the proposed approach may separate the SMM into 2 stages: SMM-I and SMM-II. Hardware enhancements to the CPU have been proposed to support two-stage SMM—an SMI remap layer, and/or a per-partition SMI_CMD. SMM-I/SMM-II Entry/Exit Flows have been presented for SMM-II Entry/Exit without escalation to SMM-I, SMM-II with escalation to SMM-I, SMM-I using SMM-II as bottom half (SMM-I first) and cross-SMM-II messaging/redirection.

In other hardware partitioning approaches, the system firmware (including BIOS and SMM) may not be prepared to handle partition-specific RAS/error event differently from platform common RAS/error events. Moreover, the proposed approach may also apply to partition implementations with more shared resources.

The proposed approach provides a two-stage SMM and its associated entry/exit flow. In other systems, when SMI is triggered, all cores may enter SMM mode and stop running user work-load. With the proposed approach, SMI in one partition might not affect cores in other partitions. Both hardware and software changes may be applied to implement the invention. In hardware, SMI signal wiring inside CPU may be adapted to incorporate a partition layer, in addition to per core signaling and one global signal. In software, firmware changes may be used to handle the SMM-I/SMM-II entry/exit flow.

More details and aspects of the two-stage SMM system firmware architecture for a partitioned server platform are mentioned in connection with the proposed approach or one or more examples described above or below (e.g. FIG. 1a to 2b). The two-stage SMM system firmware architecture for a partitioned server platform may comprise one or more additional optional features corresponding to one or more aspects of the proposed approach, or one or more examples described above or below.

In the following, some examples of the proposed approach are presented:

An example (e.g., example 1) relates to a firmware apparatus (10) for a computer system (100), the firmware apparatus comprising interface circuitry (12), machine-readable instructions and processing circuitry (14) to execute the machine-readable instructions to provide a first entry point (102) for handling global system interrupts. The machine-readable instructions comprise instructions to provide a plurality of second entry points (104) for handling hardware partition-specific system interrupts, the plurality of second entry points being based on a plurality of hardware partitions of the computer system.

Another example (e.g., example 2) relates to a previously described example (e.g., example 1) or to any of the examples described herein, further comprising that the machine-readable instructions comprise instructions for handling the interrupts obtained via the first entry point and via the second entry points.

Another example (e.g., example 3) relates to a previously described example (e.g., example 2) or to any of the examples described herein, further comprising that the machine-readable instructions comprise instructions to perform, based on a hardware partition-specific system interrupt obtained via a second entry point, one or more hardware partition-specific operations in a context of the second entry point, the context of the second entry point affecting the hardware partition associated with the second entry point.

Another example (e.g., example 4) relates to a previously described example (e.g., one of the examples 2 to 3) or to any of the examples described herein, further comprising that the machine-readable instructions comprise instructions to perform, based on a global system interrupt obtained via the first entry point, one or more common operations in a context of the first entry point, the context of the first entry point affecting the plurality of hardware partitions.

Another example (e.g., example 5) relates to a previously described example (e.g., one of the examples 1 to 4) or to any of the examples described herein, further comprising that the machine-readable instructions comprise instructions to activate, for one or more operations to be performed in the context of the first entry point, a system management mode of a processor of the computer system, and to activate, for one or more operations to be performed in the context of the second entry point, a system management mode of one or more processor cores of the processor, the one or more processor cores being part of a hardware partition associated with the second entry point.

Another example (e.g., example 6) relates to a previously described example (e.g., example 5) or to any of the examples described herein, further comprising that the interrupt is initially handled by a processor core of the processor, wherein the machine-readable instructions comprise instructions to notify, for one or more operations to be performed in the context of the first entry point, the other processor cores of the processors to activate the system management mode, and to notify, for one or more operations to be performed in the context of the second entry point, the one or more processor cores being part of a hardware partition associated with the second entry point, to activate the system management mode.

Another example (e.g., example 7) relates to a previously described example (e.g., one of the examples 1 to 6) or to any of the examples described herein, further comprising that the machine-readable instructions comprise instructions to determine, for an interrupt obtained via one of the second entry points, whether the interrupt is a hardware partition-specific system interrupt that is specifically relevant to the hardware partition associated with the second entry point or a global system interrupt that is commonly relevant for the computer system, and to forward the interrupt to the first entry point if the interrupt is a global system interrupt that is commonly relevant for the computer system.

Another example (e.g., example 8) relates to a previously described example (e.g., one of the examples 1 to 7) or to any of the examples described herein, further comprising that the machine-readable instructions comprise instructions to determine, for an interrupt obtained via the first or via a second entry point, one or more hardware partition-specific operations and one or more common operations to be performed, to perform the one or more hardware partition-specific operations in the context of the second entry point, and to perform the one or more common operations in the context of the first entry point.

Another example (e.g., example 9) relates to a previously described example (e.g., one of the examples 6 to 8) or to any of the examples described herein, further comprising that the context of the second entry point affects the hardware partition associated with the second entry point, and the context of the first entry point affects the plurality of hardware partitions.

Another example (e.g., example 10) relates to a previously described example (e.g., one of the examples 1 to 9) or to any of the examples described herein, further comprising that the machine-readable instructions comprise instructions to provide a separate second entry point for each hardware partition of the computer system.

Another example (e.g., example 11) relates to a previously described example (e.g., one of the examples 1 to 10) or to any of the examples described herein, further comprising that the firmware apparatus implements a system firmware of the computer system.

Another example (e.g., example 12) relates to a previously described example (e.g., example 11) or to any of the examples described herein, further comprising that the machine-readable instructions comprise instructions to load a first system firmware portion and a plurality of second firmware portions, the first system firmware portion affecting the plurality of hardware partitions and the plurality of second firmware portions each affecting one of the plurality hardware partitions, with the first entry point being provided by the first system firmware portion and the plurality of second entry points by the first system firmware portion or by the plurality of second firmware portions

Another example (e.g., example 13) relates to a previously described example (e.g., one of the examples 1 to 12) or to any of the examples described herein, further comprising that the global system interrupts and the hardware partition-specific system interrupts are system management interrupts (SMIs).

An example (e.g., example 14) relates to a processor (20) comprising a plurality of processor cores (22) and control circuitry (24) to obtain a signal with respect to a system interrupt to be triggered. The control circuitry is to determine, based on at least one of a source of the signal and a content of the signal, at least a subset of the plurality of cores that is to be notified of the system interrupt to be triggered. The control circuitry is to provide a system interrupt signal to at least the subset of the cores (22).

Another example (e.g., example 15) relates to a previously described example (e.g., example 14) or to any of the examples described herein, further comprising that the determination of at least the subset of the plurality of cores is based on a hardware partitioning of at least one of the processor and a computer system (100) hosting the processor.

Another example (e.g., example 16) relates to a previously described example (e.g., example 15) or to any of the examples described herein, further comprising that the determination of at least the subset of the plurality of cores is based on whether the source or content of the signal relates to a global resource that is used by multiple hardware partitions or to a local resource that is used by one of the hardware partitions.

Another example (e.g., example 17) relates to a previously described example (e.g., example 16) or to any of the examples described herein, further comprising that the processor comprises a memory (26) with a mapping between resources and hardware partitions.

Another example (e.g., example 18) relates to a previously described example (e.g., one of the examples 14 to 17) or to any of the examples described herein, further comprising that the control circuitry is to distinguish between global system interrupts to be triggered for the plurality of processor cores and hardware partition-specific interrupts to be triggered for a subset of the processor cores.

Another example (e.g., example 19) relates to a previously described example (e.g., example 18) or to any of the examples described herein, further comprising that the control circuitry is to expose a first system interrupt command for global system interrupts and a plurality of second system interrupt commands for hardware partition-specific interrupts, with a separate second system interrupt command being exposed for each hardware partition.

An example (e.g., example 20) relates to a computer system (100, 200) comprising the firmware apparatus according to one of the examples 1 to 13 (or according to any other example).

Another example (e.g., example 21) relates to a previously described example (e.g., example 20) or to any of the examples described herein, further comprising the processor according to one of the examples 14 to 19 (or according to any other example).

An example (e.g., example 22) relates to a computer system (100, 200) comprising the processor (20) according to one of the examples 14 to 19 (or according to any other example).

An example (e.g., example 23) relates to a firmware apparatus (10) for a computer system (100), the firmware apparatus comprising processing circuitry configured to provide a first entry point (102) for handling global system interrupts. The processing circuitry is configured to provide a plurality of second entry points (104) for handling hardware partition-specific system interrupts, the plurality of second entry points being based on a plurality of hardware partitions of the computer system.

An example (e.g., example 24) relates to a processor (20) comprising a plurality of processor cores (22) and control circuitry (24) configured to obtain a signal with respect to a system interrupt to be triggered. The control circuitry is configured to determine, based on at least one of a source of the signal and a content of the signal, at least a subset of the plurality of cores that is to be notified of the system interrupt to be triggered. The control circuitry is configured to provide a system interrupt signal to at least the subset of the cores (22).

An example (e.g., example 25) relates to a computer system (100, 200) comprising the firmware apparatus according to example 23 (or according to any other example).

Another example (e.g., example 26) relates to a previously described example (e.g., example 25) or to any of the examples described herein, further comprising the processor according to example 24 (or according to any other example).

An example (e.g., example 27) relates to a computer system (100, 200) comprising the processor (20) according to example 24 (or according to any other example).

An example (e.g., example 28) relates to a firmware device (10) for a computer system (100), the firmware device comprising means for processing for providing a first entry point (102) for handling global system interrupts. The means for processing is for providing a plurality of second entry points (104) for handling hardware partition-specific system interrupts, the plurality of second entry points being based on a plurality of hardware partitions of the computer system.

An example (e.g., example 29) relates to a processor (20) comprising a plurality of processor cores (22) and means for controlling (24) for obtaining a signal with respect to a system interrupt to be triggered. The means for controlling is for determining, based on at least one of a source of the signal and a content of the signal, at least a subset of the plurality of cores that is to be notified of the system interrupt to be triggered. The means for controlling is for providing a system interrupt signal to at least the subset of the cores (22).

An example (e.g., example 30) relates to a computer system (100, 200) comprising the firmware device according to example 28 (or according to any other example).

Another example (e.g., example 31) relates to a previously described example (e.g., example 30) or to any of the examples described herein, further comprising the processor according to example 29 (or according to any other example).

An example (e.g., example 32) relates to a computer system (100, 200) comprising the processor (20) according to example 29 (or according to any other example).

An example (e.g., example 33) relates to a firmware method for a computer system (100), the firmware method comprising providing (115) a first entry point (102) for handling global system interrupts. The firmware method comprises providing (125) a plurality of second entry points (104) for handling hardware partition-specific system interrupts, the plurality of second entry points being based on a plurality of hardware partitions of the computer system.

Another example (e.g., example 34) relates to a previously described example (e.g., example 33) or to any of the examples described herein, further comprising that the method comprises handling (130) the interrupts obtained via the first entry point and via the second entry points. Another example (e.g., example 35) relates to a previously described example (e.g., example 34) or to any of the examples described herein, further comprising that the method comprises performing (170), based on a hardware partition-specific system interrupt obtained via a second entry point, one or more hardware partition-specific operations in a context of the second entry point, the context of the second entry point affecting the hardware partition associated with the second entry point.

Another example (e.g., example 36) relates to a previously described example (e.g., one of the examples 34 to 35) or to any of the examples described herein, further comprising that the method comprises performing (160), based on a global system interrupt obtained via the first entry point, one or more common operations in a context of the first entry point, the context of the first entry point affecting the plurality of hardware partitions.

Another example (e.g., example 37) relates to a previously described example (e.g., one of the examples 33 to 36) or to any of the examples described herein, further comprising that the method comprises activating (165), for one or more operations to be performed in the context of the first entry point, a system management mode of a processor of the computer system, and activating (175), for one or more operations to be performed in the context of the second entry point, a system management mode of one or more processor cores of the processor, the one or more processor cores being part of a hardware partition associated with the second entry point.

Another example (e.g., example 38) relates to a previously described example (e.g., example 37) or to any of the examples described herein, further comprising that the interrupt is initially handled by a processor core of the processor, wherein the method comprises notifying, for one or more operations to be performed in the context of the first entry point, the other processor cores of the processors to activate the system management mode, and to notify, for one or more operations to be performed in the context of the second entry point, the one or more processor cores being part of a hardware partition associated with the second entry point, to activate the system management mode.

Another example (e.g., example 39) relates to a previously described example (e.g., one of the examples 33 to 38) or to any of the examples described herein, further comprising that the method comprises determining (140), for an interrupt obtained via one of the second entry points, whether the interrupt is a hardware partition-specific system interrupt that is specifically relevant to the hardware partition associated with the second entry point or a global system interrupt that is commonly relevant for the computer system, and forwarding (145) the interrupt to the first entry point if the interrupt is a global system interrupt that is commonly relevant for the computer system.

Another example (e.g., example 40) relates to a previously described example (e.g., one of the examples 33 to 39) or to any of the examples described herein, further comprising that the method comprises determining (150), for an interrupt obtained via the first or via a second entry point, one or more hardware partition-specific operations and one or more common operations to be performed, performing (170) the one or more hardware partition-specific operations in the context of the second entry point, and performing (160) the one or more common operations in the context of the first entry point.

Another example (e.g., example 41) relates to a previously described example (e.g., one of the examples 38 to 40) or to any of the examples described herein, further comprising that the context of the second entry point affects the hardware partition associated with the second entry point, and the context of the first entry point affects the plurality of hardware partitions.

Another example (e.g., example 42) relates to a previously described example (e.g., one of the examples 33 to 41) or to any of the examples described herein, further comprising that the method comprises providing (125) a separate second entry point for each hardware partition of the computer system.

Another example (e.g., example 43) relates to a previously described example (e.g., one of the examples 33 to 42) or to any of the examples described herein, further comprising that the method is performed by a system firmware (10) of the computer system.

Another example (e.g., example 44) relates to a previously described example (e.g., example 43) or to any of the examples described herein, further comprising that the method comprises loading (110) a first system firmware portion and loading (120) a plurality of second firmware portions, the first system firmware portion affecting the plurality of hardware partitions and the plurality of second firmware portions each affecting one of the plurality hardware partitions, with the first entry point being provided by the first system firmware portion and the plurality of second entry points by the first system firmware portion or by the plurality of second firmware portions.

Another example (e.g., example 45) relates to a previously described example (e.g., one of the examples 33 to 44) or to any of the examples described herein, further comprising that the global system interrupts and the hardware partition-specific system interrupts are system management interrupts (SMIs).

An example (e.g., example 46) relates to a method for a processor (20) comprising a plurality of processor cores (22), the method comprising obtaining (230) a signal with respect to a system interrupt to be triggered. The method comprises determining (240), based on at least one of a source of the signal and a content of the signal, at least a subset of the plurality of cores that is to be notified of the system interrupt to be triggered. The method comprises providing (250) a system interrupt signal to at least the subset of the cores (22).

Another example (e.g., example 47) relates to a previously described example (e.g., example 46) or to any of the examples described herein, further comprising that the determination of at least the subset of the plurality of cores is based on a hardware partitioning of at least one of the processor and a computer system (100, 200) hosting the processor.

Another example (e.g., example 48) relates to a previously described example (e.g., example 47) or to any of the examples described herein, further comprising that the determination of at least the subset of the plurality of cores is based on whether the source or content of the signal relates to a global resource that is used by multiple hardware partitions or to a local resource that is used by one of the hardware partitions.

Another example (e.g., example 49) relates to a previously described example (e.g., example 48) or to any of the examples described herein, further comprising that the processor comprises a memory (26) with a mapping between resources and hardware partitions.

Another example (e.g., example 50) relates to a previously described example (e.g., one of the examples 46 to 49) or to any of the examples described herein, further comprising that the method comprises distinguishing between global system interrupts to be triggered for the plurality of processor cores and hardware partition-specific interrupts to be triggered for a subset of the processor cores.

Another example (e.g., example 51) relates to a previously described example (e.g., example 50) or to any of the examples described herein, further comprising that the method comprises exposing (210) a first system interrupt command for global system interrupts and exposing (220) a plurality of second system interrupt commands for hardware partition-specific interrupts, with a separate second system interrupt command being exposed for each hardware partition.

An example (e.g., example 52) relates to a non-transitory machine-readable storage medium including program code, when executed, to cause a machine to perform the method of one of the examples 33 to 45 (or according to any other example) or the method according to one of the examples 46 to 51 (or according to any other example).

An example (e.g., example 53) relates to a computer program having a program code for performing the method of one of the examples 33 to 45 (or according to any other example) or the method according to one of the examples 46 to 51 (or according to any other example) when the computer program is executed on a computer, a processor, or a programmable hardware component.

An example (e.g., example 54) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), ap-plication-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1-25. (canceled)

26. A firmware apparatus for a computer system, the firmware apparatus comprising interface circuitry, machine-readable instructions and processing circuitry to execute the machine-readable instructions to:
provide a first entry point for handling global system interrupts; and
provide a plurality of second entry points for handling hardware partition-specific system interrupts, the plurality of second entry points being based on a plurality of hardware partitions of the computer system.

27. The firmware apparatus according to claim 26, wherein the processing circuitry is to execute the machine-readable instructions to handle the interrupts obtained via the first entry point and via the second entry points.

28. The firmware apparatus according to claim 27, wherein the processing circuitry is to execute the machine-readable instructions to perform, based on a hardware partition-specific system interrupt obtained via a second entry point, one or more hardware partition-specific operations in a context of the second entry point, the context of the second entry point affecting the hardware partition associated with the second entry point.

29. The firmware apparatus according to claim 27, wherein the processing circuitry is to execute the machine-readable instructions to perform, based on a global system interrupt obtained via the first entry point, one or more common operations in a context of the first entry point, the context of the first entry point affecting the plurality of hardware partitions.

30. The firmware apparatus according to claim 26, wherein the processing circuitry is to execute the machine-readable instructions to activate, for one or more operations to be performed in the context of the first entry point, a system management mode of a processor of the computer system, and to activate, for one or more operations to be performed in the context of the second entry point, a system management mode of one or more processor cores of the processor, the one or more processor cores being part of a hardware partition associated with the second entry point.

31. The firmware apparatus according to claim 30, wherein the interrupt is initially handled by a processor core of the processor, wherein the processing circuitry is to execute the machine-readable instructions to notify, for one or more operations to be performed in the context of the first entry point, the other processor cores of the processors to activate the system management mode, and to notify, for one or more operations to be performed in the context of the second entry point, the one or more processor cores being part of a hardware partition associated with the second entry point, to activate the system management mode.

32. The firmware apparatus according to claim 26, wherein the processing circuitry is to execute the machine-readable instructions to determine, for an interrupt obtained via one of the second entry points, whether the interrupt is a hardware partition-specific system interrupt that is specifically relevant to the hardware partition associated with the second entry point or a global system interrupt that is commonly relevant for the computer system, and to forward the interrupt to the first entry point if the interrupt is a global system interrupt that is commonly relevant for the computer system.

33. The firmware apparatus according to claim 26, wherein the processing circuitry is to execute the machine-readable instructions to determine, for an interrupt obtained via the first or via a second entry point, one or more hardware partition-specific operations and one or more common operations to be performed, to perform the one or more hardware partition-specific operations in the context of the second entry point, and to perform the one or more common operations in the context of the first entry point.

34. The firmware apparatus according to claim 31, wherein the context of the second entry point affects the hardware partition associated with the second entry point, and the context of the first entry point affects the plurality of hardware partitions.

35. The firmware apparatus according to claim 26, wherein the processing circuitry is to execute the machine-readable instructions to provide a separate second entry point for each hardware partition of the computer system.

36. The firmware apparatus according to claim 26, wherein the firmware apparatus implements a system firmware of the computer system.

37. The firmware apparatus according to claim 36, wherein the processing circuitry is to execute the machine-readable instructions to load a first system firmware portion and a plurality of second firmware portions, the first system firmware portion affecting the plurality of hardware partitions and the plurality of second firmware portions each affecting one of the plurality hardware partitions, with the first entry point being provided by the first system firmware portion and the plurality of second entry points by the first system firmware portion or by the plurality of second firmware portions

38. The firmware apparatus according to claim 37, wherein the global system interrupts and the hardware partition-specific system interrupts are system management interrupts (SMIs).

39. A processor comprising a plurality of processor cores and control circuitry to:
obtain a signal with respect to a system interrupt to be triggered;
determine, based on at least one of a source of the signal and a content of the signal, at least a subset of the plurality of cores that is to be notified of the system interrupt to be triggered; and
provide a system interrupt signal to at least the subset of the cores.

40. The processor according to claim 39, wherein the determination of at least the subset of the plurality of cores is based on a hardware partitioning of at least one of the processor and a computer system hosting the processor.

41. The processor according to claim 40, wherein the determination of at least the subset of the plurality of cores is based on whether the source or content of the signal relates to a global resource that is used by multiple hardware partitions or to a local resource that is used by one of the hardware partitions.

42. The processor according to claim 41, wherein the processor comprises a memory with a mapping between resources and hardware partitions.

43. The processor according to claim 39, wherein the control circuitry is to distinguish between global system interrupts to be triggered for the plurality of processor cores and hardware partition-specific interrupts to be triggered for a subset of the processor cores.

44. The processor according to claim 43, wherein the control circuitry is to expose a first system interrupt command for global system interrupts and a plurality of second system interrupt commands for hardware partition-specific interrupts, with a separate second system interrupt command being exposed for each hardware partition.

45. A non-transitory machine-readable storage medium including program code, when executed, to cause a machine to perform a firmware method for a computer system, the firmware method comprising:
providing a first entry point for handling global system interrupts; and
providing a plurality of second entry points for handling hardware partition-specific system interrupts, the plurality of second entry points being based on a plurality of hardware partitions of the computer system.
